(19) United States
(12) Patent Application Publication
(10) Pub. No.: US 2009/0051166 A1
(43) Pub. Date: Feb. 26, 2009

(54) Clamp-fitting stop

(75) Inventor: Robert F. Fay, York, PA (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: Murray Corporation, Hunt Valley, MD (US)

(21) Appl. No.: 12/152,953

(22) Filed: May 19, 2008

Related U.S. Application Data
(60) Provisional application No. 60/930,595, filed on May 17, 2007.

(51) Int. Cl. F16L 21/08

(52) U.S. Cl. 285/398

(57) ABSTRACT

A holding device for securing a hose clamp in position relative to a tubular fitting connection over which a hose, tube, or pipe is to be positioned. The device is adapted to hold the clamp and maintain the clamp in position on the hose, tube, or pipe. The clamp is positioned orthogonally relative to the hose, tube, or pipe and the assembly is then ready for engagement on a rigid tubular fitting with the holding device positioned on the hose, tube, or pipe adjacent to the tubular fitting. This permits the hose, tube, or pipe to be engaged over the tubular fitting and the holding device to engage the tubular fitting.

### CROSS REFERENCE TO RELATED APPLICATION

This application is based upon and claims benefit of copending and co-owned U.S. Provisional Patent Application Ser. No. 60/930,595 entitled “Clamp-fitting Stop”, filed with the U.S. Patent and Trademark Office on May 17, 2007 by the inventor herein, the specification of which is incorporated herein by reference.

### BACKGROUND OF THE INVENTION

1. Field of the Invention

The present invention relates to a device for securing a hose clamp in position relative to a rigid tubular fitting to which a hose or tube is connected. More particularly the invention relates to a hose clamp holding device to position and retain a clamp on a hose ready to be activated after the hose has been positioned over one of such rigid tubular fittings.

2. Background of the Prior Art

Hose clamps have been designed in a great variety of forms that fall into three general types. A first of these types is a continuous band that includes an upstanding portion or “ear” which can be deformed after assembly to tension the band around a hose. Such clamps are sometimes referred to as “Oetiker” clamps after the inventor. The clamps are engaged on a hose by using a special tool to deform the ear and thereby tension the band to apply a compressive radial stress on the hose.

A second type of clamp includes a mechanical actuator, such as a worm screw, acting directly on a band to bring the band into firm engagement with the hose. Lastly, the third type is a clamp of spring steel made to have a diameter slightly less than that of the outside diameter of the hose. As a result, when the clamp is pre-loaded by deforming it to enlarge the clamp, there will be stored energy in the clamp that can be released to apply a compressive radial force to hold the clamp on the hose.

Examples of clamp holding devices are found in U.S. Pat. Nos. 4,882,814; 5,234,233; 5,749,603; 5,915,739; and 6,701,581. Typically, such structures are arranged about the clamp at the location of the clamp on the hose. When the hose is pushed onto a rigid tubular fitting, the hose must be free to expand slightly and this expansion should not be impeded by the mechanical structure.

Furthermore, recent advancements in tubing manufacture incorporate an internal metal sleeve in plastic piping. Such metal sleeve is typically made of aluminum. Over time, a connection between the fitting, typically brass, and the aluminum may cause increased dielectric corrosion.

There remains a need for a holding device in which the clamp is automatically positioned relative to the fitting and the end of the pipe, in order to maximize sealing efficiency and to eliminate time spent by the installer positioning the clamp relative to the tube end prior to crimping of the clamp. Further, there remains a need for a holding device that can provide insulation between the end of the pipe and the fitting.

### SUMMARY OF THE INVENTION

The present invention enables a clamp holding device to position a clamp relative to the end of the pipe and hold the clamp in place on the fitting and tube prior to crimping, so that the clamp does not slip out of position prior to starting to crimp the clamp.

It is therefore an object of the present invention to provide an improved holding device that is suitable for hose clamps in the form of a continuous band that includes an upstanding portion or “ear,” which can be deformed after assembly to tension the band around a pipe. The holding device of the present invention enables more secure retention of the hose clamp when in both the open and closed positions of the hose clamp than achieved by prior holding devices.

The holding device has a plurality of fingers connected together at one end by a connecting body and arranged approximately parallel to the axis of the holding device along a circumference of a substantially circular region about the axis, i.e., the fingers are positioned substantially equidistant from the axis. The fingers are sized and configured to enable the bands of the clamp to move freely around the pipe and to allow for crimping of the clamp.

In accordance with the above objects, a connecting body surrounds a tubular element, in particular a pipe connection onto which a hose is to be pushed. The holding device, together with the hose clamp accommodated therein, retains a defined position relative to the tubular element until the pipe is inserted between the tubular element and the hose clamp. The clamp can then be closed precisely in the desired position on the pipe so that it securely clamps the pipe on the tubular element.

Other objects and advantages of this invention will become apparent from the following description taken in conjunction with the accompanying drawings wherein are set forth, by way of illustration and example, certain embodiments of this invention. The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows a top view of a clamp-fitting stop according to a first embodiment of the present invention.

FIG. 2 shows a bottom view of a clamp-fitting stop according to a first embodiment of the present invention.

FIG. 3 shows a longitudinal cross section of a clamp-fitting stop taken along the line A-A of FIG. 2.

FIG. 4 shows a transverse cross section of the clamp-fitting stop of FIG. 3, taken along the line B-B.

FIG. 5 shows a transverse cross section of the clamp-fitting stop of FIG. 3, taken along the line C-C.

FIG. 6 shows a transverse cross section of the clamp-fitting stop of FIG. 3, taken along the line D-D.

### DESCRIPTION OF EXEMPLARY EMBODIMENTS

The invention summarized above and defined by the enumerated claims may be better understood by referring to the following description, which should be read in conjunction with the accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

The present invention discloses a new design for a plumbing fitting to be used with PEX and PEX-aluminum-PEX pipe in hot and cold-water distribution systems. The design incorporates a feature to secure a PEX pinch clamp to a plumbing fitting. The clamp is automatically positioned relative to the plumbing fitting and the end of the pipe, which maximizes sealing efficiency and eliminates time spent by the installer positioning the clamp relative to the tube end prior to crimping of the clamp. The clamp is held in place on the plumbing fitting and tube prior to crimping, so that the clamp does not slip on a vertical pipe run prior to starting the crimp.

A holding device according to the present invention is provided for positioning and retaining an open generally cylindrical clamp on a selected pipe. The holding device is adapted to hold the clamp and maintain the clamp in position on the pipe. The clamp is positioned orthogonally relative to the pipe and the assembly is then ready for engagement on a rigid tubular fitting with the holding device positioned on the pipe adjacent to the tubular fitting. This permits the pipe to be engaged over the tubular fitting and the holding device to engage the tubular fitting.

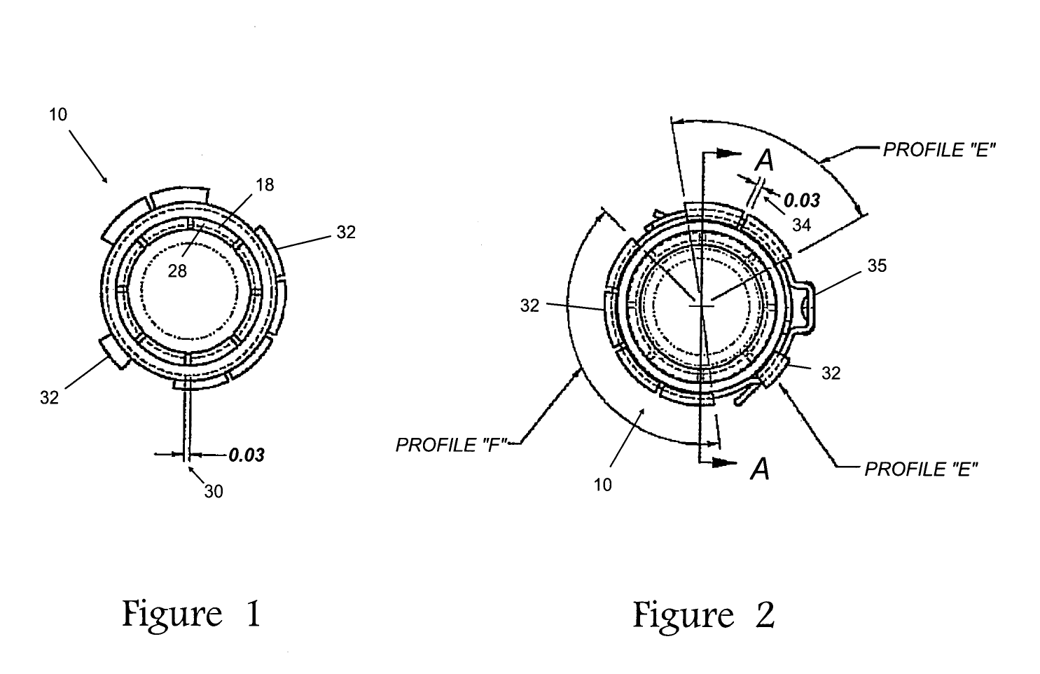

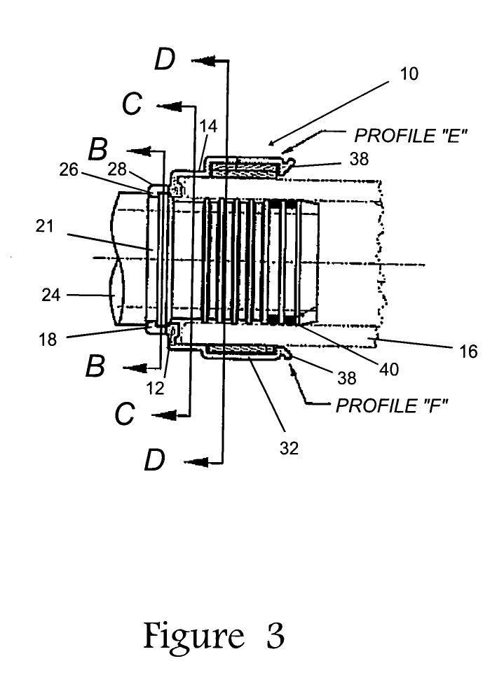

Referring to the drawings, an example of a clamp-fitting stop according to the present invention is shown. The example embodiment shows a ¾″ PEX tube, other sizes of tube can be used. FIGS. 1 and 2 show a top and bottom view of a clamp-fitting stop, indicated generally as 10, according to the present invention. The clamp-fitting stop 10 is generally cylindrical to fit around a tube 16 (FIG. 3). In a preferred embodiment, the clamp-fitting stop 10 is constructed of a plastic or other flexible material. One skilled in the art will select an appropriate material for its ability to be molded and to be flexible.

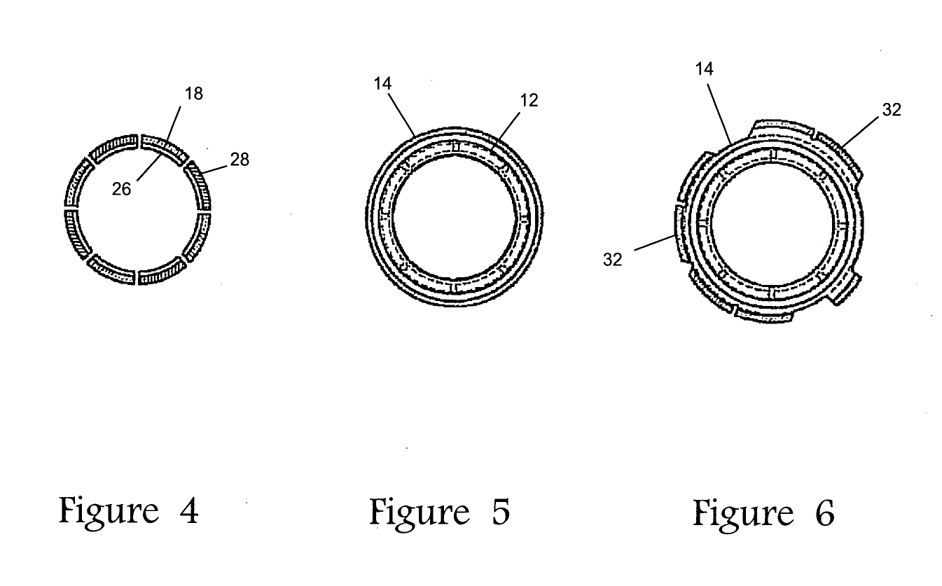

The clamp-fitting stop 10 includes a circular hub 12 and body portion 14 (FIG. 3). On a first end of the clamp-fitting stop 10, shown in FIG. 1, a plurality of short tabs 28 extending in an orthogonal direction from hub 12 may be provided. The tabs 28 may have clip elements 18 that can engage in a groove 21 around a fitting 24 to which the tube 16 is to be attached. Each clip element 18 typically comprises a hook 26 on the end of each tab 28. The hooks 26 are sized and configured to engage the groove 21 when the clamp-fitting stop 10, hence the tube 16, is properly installed. As shown in FIG. 4, in a typical embodiment, eight tabs 28 may be equally spaced around the circumference of the clamp-fitting stop 10, each tab having approximately 0.03″ spacing from each adjacent tab 28, as shown at 30 (FIG. 1). In some embodiments, tabs 28 and clip elements 18 will not be provided, such that the hub 12 and body portion 14 will be the first end of the clamp-fitting stop 10.

The hub 12 and body portion 14 form an unbroken cylindrical shape, as shown in FIG. 5. On a second end of the clamp-fitting stop 10, a plurality of fingers 32 extending in an orthogonal direction from the body portion 14 is provided. The fingers 32 are sized and configured to engage a clamp 35 (FIG. 2) and hold it in place on the tube 16. The fingers 32 may be provided in a variety of profiles. For example, a first profile, labeled Profile “E”, provides sufficient clearance for two bands of the clamp 35. A second profile, labeled Profile “F”, provides sufficient clearance for a single band of the clamp 35. (Profiles “E” and “F” are best seen in FIG. 3.) Other profiles, as one skilled in the art can determine, may be used. The outer ends of the fingers 32 may have a guide lip 38 to enable ease of placing the clamp-fitting stop 10 on a tube 16. As shown in FIGS. 1 and 2, the fingers 32 need not be placed all the way around the circumference of the clamp-fitting stop 10. For example, in a typical embodiment, there will be no finger provided in the position where the closing element for the clamp 35 is located. Other spaces may be left, depending on the construction of the clamp 35, as can easily be determined by one skilled in the relevant art. In a preferred embodiment, each finger 32 will have approximately 0.03″ spacing from each adjacent finger 32, as shown at 34.

The body portion 14 is circumferentially sized to fit around the outside of the tube 16. The hub 12 is somewhat smaller and is circumferentially sized to provide a stop for the tube 16 when placed in the clamp-fitting stop 10. The hub 12 can also provide a barrier between the end of the tube 16 and the fitting 24. In use, a clamp 35 is first placed over the end of the tube 16. The clamp-fitting stop 10 can then be assembled on the end of the tube 16 so that the distal end of the tube 16 butts against the hub 12. The clamp 35 can then be placed in position under the fingers 32 of the clamp-fitting stop 10 while aligning appropriate profiles. With the tube 16 fully engaged in the clamp-fitting stop 10 (that is, with the distal end of the tube 16 against the hub 12), the clamp 35 is automatically positioned on the tube 16 to maximize sealing efficiency. When the tube 16 is then placed on a tubular fitting 24, the clamp 35 maintains optimal position relative to the fitting 24 and the end of the tube 16.

In a preferred embodiment, the fitting 24 may be provided with O-rings 40 situated in an appropriate place on the fitting 24, also to maximize sealing efficiency.

The invention has been described with references to exemplary embodiments. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It should be understood, therefore, that the invention may be practiced otherwise than as specifically set forth herein. Consequently, the present embodiments are to be considered in all respects as illustrative and not restrictive.

What is claimed is:

1. A clamp-fitting stop, comprising:
a substantially cylindrical shaped body having a first end and a second end;
a circular hub attached to the first end of said body; and
a plurality of fingers attached to the second end of said body.

2. The clamp-fitting stop of claim 1, wherein said hub has a smaller inside diameter than the body.

3. The clamp-fitting stop of claim 1, each of said plurality of fingers comprising a profile.

4. The clamp-fitting stop of claim 3, wherein said profile is configured to fit over one or more bands of a clamp.

5. The clamp-fitting stop of claim 1, further comprising:
a plurality of tabs attached to said hub.

6. The clamp-fitting stop of claim 5, wherein said tabs extend orthogonal to said hub.

7. The clamp-fitting stop of claim 5, said tabs further comprise a clip element on an end of said tab.

8. The clamp-fitting stop of claim 7, said clip elements further comprising a hook.

9. The clamp-fitting stop of claim 8, wherein said hook is sized and configured to engage a groove of a tubular fitting.

10. The clamp-fitting stop of claim 1, wherein said fingers are flexibly attached to said body.
